(19) United States
(12) Patent Application Publication
(10) Pub. No.: US 2016/0021283 A1
(43) Pub. Date: Jan. 21, 2016

(54) METHOD FOR CLEANING OFF PARTICLES WITHIN CAMERA MODULE AND CAMERA MODULE

(71) Applicant: Primax Electronics Ltd., Taipei (TW)

(72) Inventor: CHIN-DING LAI, Taipei (TW)

(21) Appl. No.: 14/548,986

(22) Filed: Nov. 20, 2014

(30) Foreign Application Priority Data
Jul. 18, 2014 (TW) 103124724

(51) Int. Cl. H04N 5/225; H04N 5/232

(52) U.S. Cl. CPC H04N 5/2254; H04N 5/23264

(57) ABSTRACT

A camera module includes a sensing chip, a lens module and a gluing element. The gluing element is disposed on the sensing chip and located at a side of the sensing region. The lens module covers the sensing chip. A lens assembly of the lens module is aligned with the sensing region. When the camera module is subject to a vibration, the particles within the camera module are moved to and adsorbed on the gluing element. Consequently, the camera module o can reduce the possibility of falling down the particles on the sensing region.

### FIELD OF THE INVENTION

The present invention relates to a camera module, and more particularly to a camera module for a portable electronic device.

### BACKGROUND OF THE INVENTION

Recently, a mobile communication device, a personal digital assistant (PDA) or other portable electronic device with an image-shooting function is widely used to shoot an object. Moreover, since the portable electronic device is easily carried, the image-shooting function becomes a basic function of the portable electronic device. That is, the portable electronic device is usually equipped with a camera module. Generally, the camera module with the basic function comprises a lens module and a sensing chip. An external light beam may be refracted by the lens module and transmitted through the lens module so as to be imaged. The sensing chip comprises a sensing region. After the external light beam is received by the sensing region, the external light beam is imaged on the sensing region. Consequently, an image is produced.

The imaging operation of the camera module is performed on the sensing region of the sensing chip. If particles are adsorbed on the sensing region, the produced image may contain black dots or stains. Consequently, the shooting quality of the image is reduced. For solving this problem, during the processes of fabricating and assembling the camera module, the demand on the cleanness of the environment is very stringent. For example, the assembling process is performed in a clean room, or the particles outside the camera module are cleaned off after the camera module is assembled.

However, during the assembling process, some particles may fall down into the internal portion of the camera module. Under this circumstance, the particles within the camera module are readily adsorbed on the sensing region. Since the camera module is completely assembled, the particles within the camera module cannot be cleaned off. Therefore, there is a need of providing a camera module and a method for cleaning off the particles within the camera module in order to reduce the possibility of falling down the particles on the sensing region.

### SUMMARY OF THE INVENTION

An object of the present invention provides a method for cleaning off particles within a camera module in order to reduce the possibility of falling down the particles on the sensing region.

Another object of the present invention provides a camera module for reducing the possibility of falling down the particles on the sensing region.

In accordance with an aspect of the present invention, there is provided a method for cleaning off particles within a camera module. Firstly, a gluing element is attached on a sensing chip of the camera module. The gluing element is located at a side of a sensing region of the sensing chip, and the gluing element is not disposed on the sensing region. Then, the sensing chip and a lens module are combined together as the camera module. Then, the camera module is subject to a vibration. The particles are moved to and adsorbed on the gluing element in response to the vibration of the camera module.

In accordance with another aspect of the present invention, there is provided a camera module. The camera module includes a sensing chip, a lens module and a gluing element. The sensing chip has a sensing region. The sensing region receives an external light beam and produces an image. The lens module covers the sensing chip. After the external light beam passes through the lens module, the external light beam strikes the sensing chip. The gluing element is disposed on the sensing chip and located at a side of the sensing region. When the camera module is subject to a vibration, particles within the camera module are moved to and adsorbed on the gluing element.

From the above descriptions, the present invention provides a method for cleaning off particles within a camera module. During the process of assembling the camera module, gluing elements are attached on a sensing element or an inner sidewall of a lens carrier. Consequently, the gluing elements are disposed within the camera module, and the gluing elements are not overlapped with the sensing region of the sensing chip. After the camera module is assembled, a vibrating means is performed to vibrate the camera module. In response to the vibration of the camera module, the particles within the camera module are moved to and adsorbed on the gluing elements. Consequently, the efficacy of preventing the particles from falling down to the sensing region is achieved. In other words, the cleaning method and the camera module of the present invention can largely reduce the possibility of falling down the particles on the sensing region while maintaining the cleanness of the sensing chip.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a camera module according to a first embodiment of the present invention;

FIG. 2 is a schematic cross-sectional view illustrating the camera module of FIG. 1;

FIG. 3 is a flowchart illustrating a method for cleaning off the particles within the camera module according to the first embodiment of the present invention;

FIGS. 4A˜4C are cross-sectional views illustrating the procedures of method for cleaning the off particles within the camera module according to the first embodiment of the present invention;

FIG. 5 is a schematic cross-sectional view illustrating a camera module according to a second embodiment of the present invention;

FIG. 6 is a flowchart illustrating a method for cleaning off the particles within the camera module according to the second embodiment of the present invention; and

FIGS. 7A˜7D are cross-sectional views illustrating the procedures of method for cleaning the off particles within the camera module according to the first embodiment of the present invention.

### DETAILED DESCRIPTION OF THE PREFERRED EMBODIMENT

For obviating the drawbacks of the prior art technologies, the present invention provides a camera module and a method for cleaning off the internal particles of the camera module.

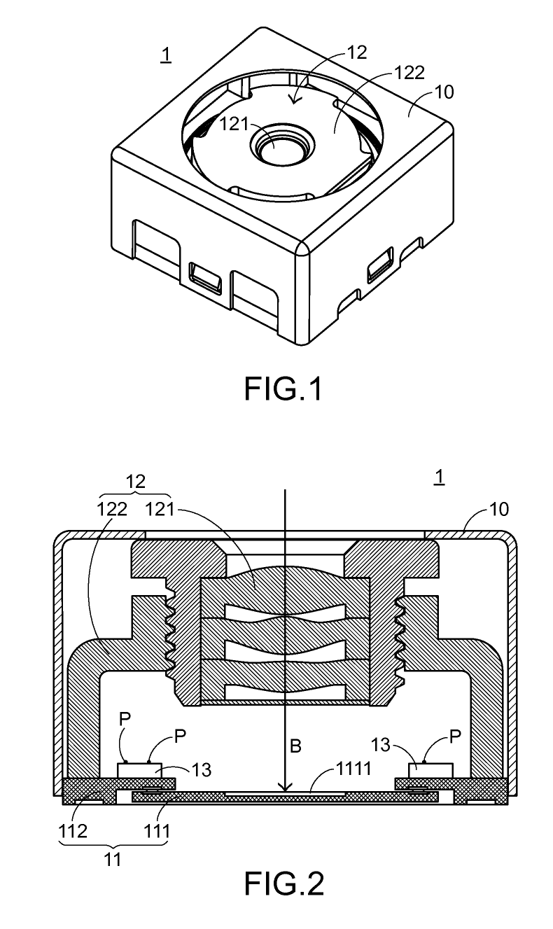

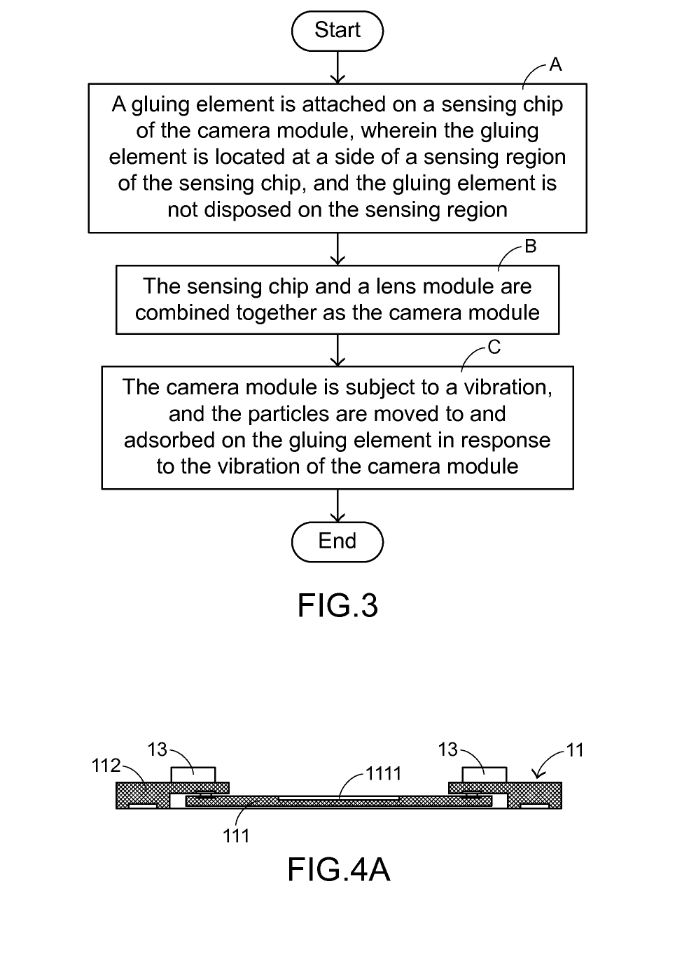

Hereinafter, a camera module of the present invention will illustrated with reference to FIGS. 1 and 2. FIG. 1 is a schematic perspective view illustrating the outward appearance of a camera module according to a first embodiment of the present invention. FIG. 2 is a schematic cross-sectional view illustrating the camera module of FIG. 1. As shown in FIGS. 1 and 2, the camera module 1 comprises a casing 10, a sensing chip 11, a lens module 12 and plural gluing elements 13. The sensing chip 11 may receive an external light beam B and produce an image. The sensing chip 11 comprises a sensing element 111 and a circuit board 112. The sensing element 111 is used for receiving the external light beam B and producing the image. The sensing element 111 has a sensing region 1111. The circuit board 112 is connected with the sensing element 111 and the lens module 12. The sensing element 111 is supported by the circuit board 112. In this embodiment, the sensing element 111 is a complementary metal-oxide-semiconductor (CMOS), and the circuit board 112 is a rigid-flex board, a FR4 substrate or a ceramic substrate.

Please refer to FIGS. 1 and 2. The sensing chip 11 is covered by the lens module 12. After the external light beam B passes through the lens module 12, the external light beam B strikes the sensing region 1111 of the sensing element 111. The lens module 12 comprises a lens assembly 121 and a lens carrier 122. The lens assembly 121 is disposed over the sensing element 111 and aligned with the sensing element 111. The lens carrier 122 is connected with the circuit board 112. In addition, the lens carrier 122 is used for supporting the lens assembly 121. The casing 10 is used for sheltering the lens module 12 in order to avoid damage of the lens module 12. The plural gluing elements 13 are disposed within the camera module 1. Due to the adhesive properties of the plural gluing elements 13, the particles P within the camera module 1 can be adsorbed by the plural gluing elements 13. In this embodiment, the lens assembly 121 is composed of plural lenses, and the gluing elements 13 are double-sided tapes.

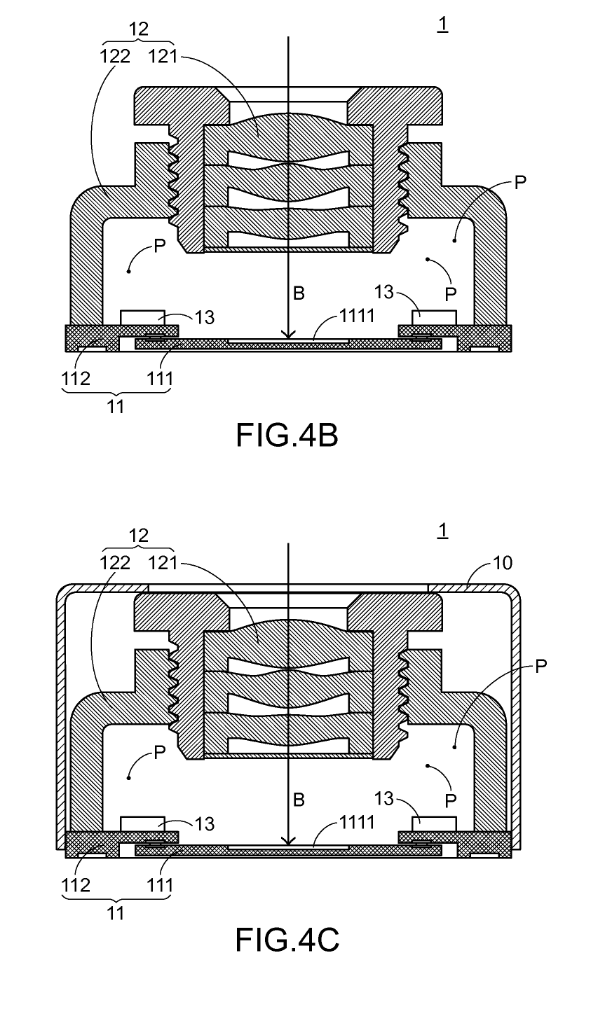

Hereinafter, a method for cleaning off the particles within the camera module will be illustrated with reference to FIG. 3. FIG. 3 is a flowchart illustrating a method for cleaning off the particles within the camera module according to the first embodiment of the present invention. The method comprises the following steps.

In a step A, a gluing element is attached on a sensing chip of the camera module. The gluing element is located at a side of a sensing region of the sensing chip, and the gluing element is not disposed on the sensing region. In a step B, the sensing chip and a lens module are combined together as the camera module. In a step C, the camera module is subject to a vibration, and the particles are moved to and adsorbed on the gluing element in response to the vibration of the camera module.

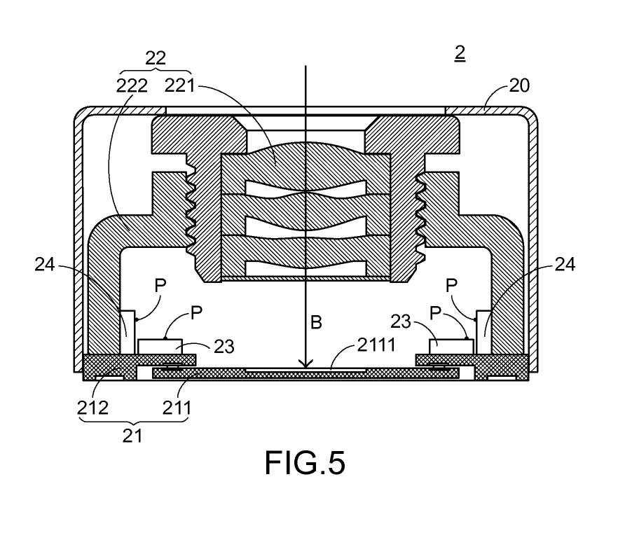

The detailed procedures of the method for cleaning off the particles within the camera module will be illustrated as follows. Please refer to FIGS. 2 and 3. For assembling the camera module 1, two gluing elements 13 are firstly attached on two sides of the sensing region 1111 of the sensing chip 11, respectively. Especially, the gluing elements 13 are not disposed on the sensing region 1111. That is, the gluing elements 13 and the sensing region 1111 are not overlapped with each other. Meanwhile, the step A is performed. After the gluing elements 13 are disposed on the sensing chip 11, the resulting structure is shown in FIG. 4A.

After the gluing elements 13 are attached on the sensing chip 11, the step B is performed. That is, the lens carrier 122 of the lens module 12 and the circuit board 112 of the sensing chip 11 are combined together. Moreover, the sensing chip 11 is covered by the lens module 121 and the lens carrier 122, and the sensing chip 11 is not exposed outside. Under this circumstance, the lens assembly 121 is disposed over the sensing element 111 and aligned with the sensing element 111 (see FIG. 4B). After the casing 10 is arranged around the lens carrier 122, the camera module 1 is assembled (see FIG. 4C). Meanwhile, the process of assembling the camera module 1 is completed. After the camera module 1 is assembled, the step C is performed. In the step C, an external force is applied to the camera module 1 to vibrate the camera module 1. In response to the vibration of the camera module 1, the plural particles P within the camera module 1 are moved to the gluing elements 13, which are located at the external sides of the sensing region 1111.

In this embodiment, the gluing elements 13 are located at two external sides of the sensing region 1111, but are not limited thereto. In another embodiment, only a single gluing element 13 is located at an external side of the sensing region 1111. Moreover, in another embodiment, plural gluing elements 13 are located at all external sides of the sensing region 1111, so that the plural gluing elements 13 are arranged around the sensing region 1111. In case that the plural gluing elements 13 are arranged around the sensing region 1111, the assembly worker may rotate the camera module 1 in order to vibrate the camera module 1. Consequently, in response to the counterforce corresponding to the centripetal force, the plural particles P within the camera module 1 are moved toward the external sides of the sensing region 1111. When the plural particles P are contacted with the gluing elements 13, the plural particles are adsorbed on the gluing elements 13 according to the adhesive properties of the gluing elements 13.

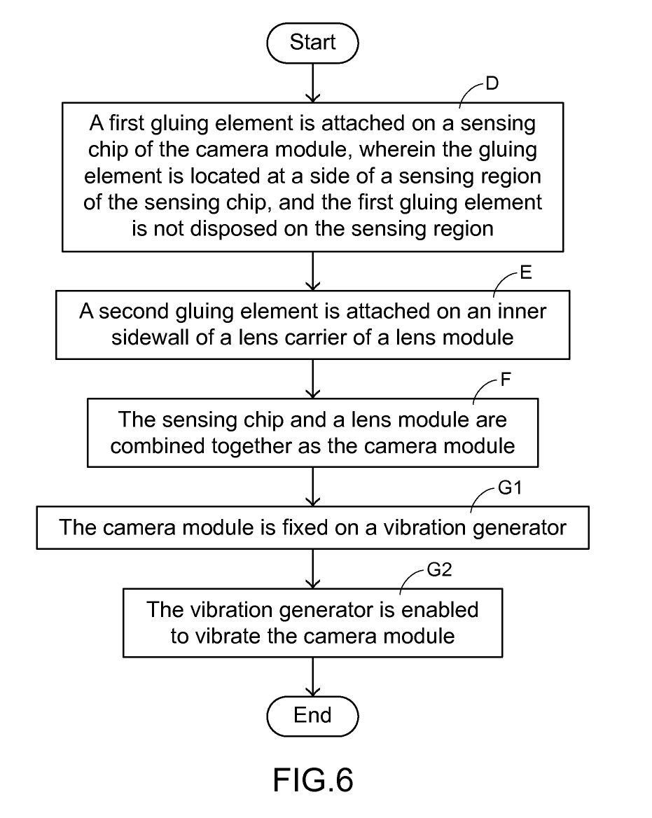

The present invention further comprises a second embodiment, which is distinguished from the first embodiment. FIG. 5 is a schematic cross-sectional view illustrating a camera module according to a second embodiment of the present invention. As shown in FIG. 5, the camera module 2 comprises a casing 20, a sensing chip 21, a lens module 22, plural first gluing elements 23 and plural second gluing elements 24. The sensing chip 21 may receive an external light beam B and produce an image. The sensing chip 21 comprises a sensing element 211 and a circuit board 212. The sensing element 211 is used for receiving the external light beam B and producing the image. The sensing element 211 has a sensing region 2111. The circuit board 212 is connected with the sensing element 211 and the lens module 22. The sensing element 211 is supported by the circuit board 212. The lens module 22 comprises a lens assembly 221 and a lens carrier 222. Except that the camera module 2 of this embodiment further comprises the plural second gluing elements 24 and the plural second gluing elements 24 are disposed on the lens carrier 222, the structures of other components of the camera module 2 are substantially identical to those of the camera module 1 of the first embodiment, and are not redundantly described herein.

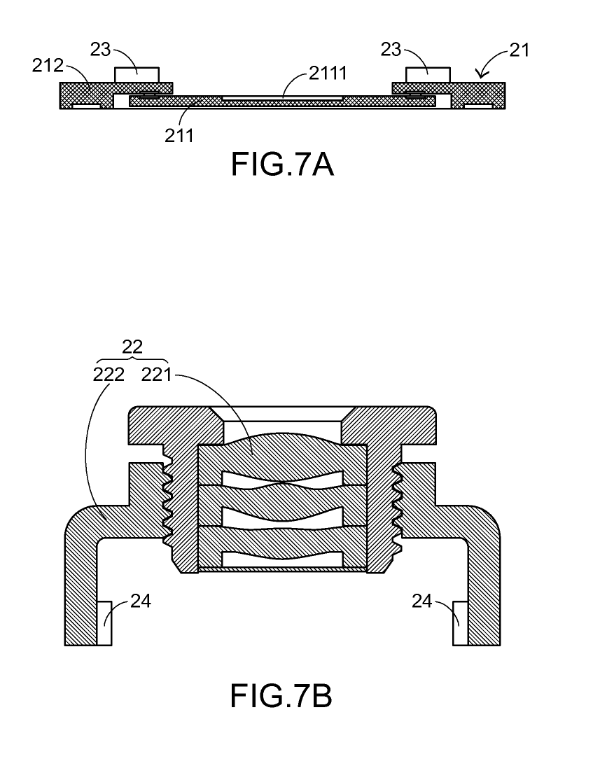

Hereinafter, a method for cleaning off the particles within the camera module will be illustrated with reference to FIG. 6. FIG. 6 is a flowchart illustrating a method for cleaning off the particles within the camera module according to the second embodiment of the present invention. The method comprises the following steps.

In a step D, a first gluing element is attached on a sensing chip of the camera module. The gluing element is located at a side of a sensing region of the sensing chip, and the first gluing element is not disposed on the sensing region. In a step E, a second gluing element is attached on an inner sidewall of a lens carrier of a lens module. In a step F, the sensing chip and the lens module are combined together as the camera module. In a step G, the camera module is subject to a vibration, and the particles are moved to and adsorbed on the gluing element in response to the vibration of the camera module.

The step G comprises sub-steps G1 and G2. In the sub-step G1, the camera module is fixed on a vibration generator. In the sub-step G2, the vibration generator is enabled to vibrate the camera module.

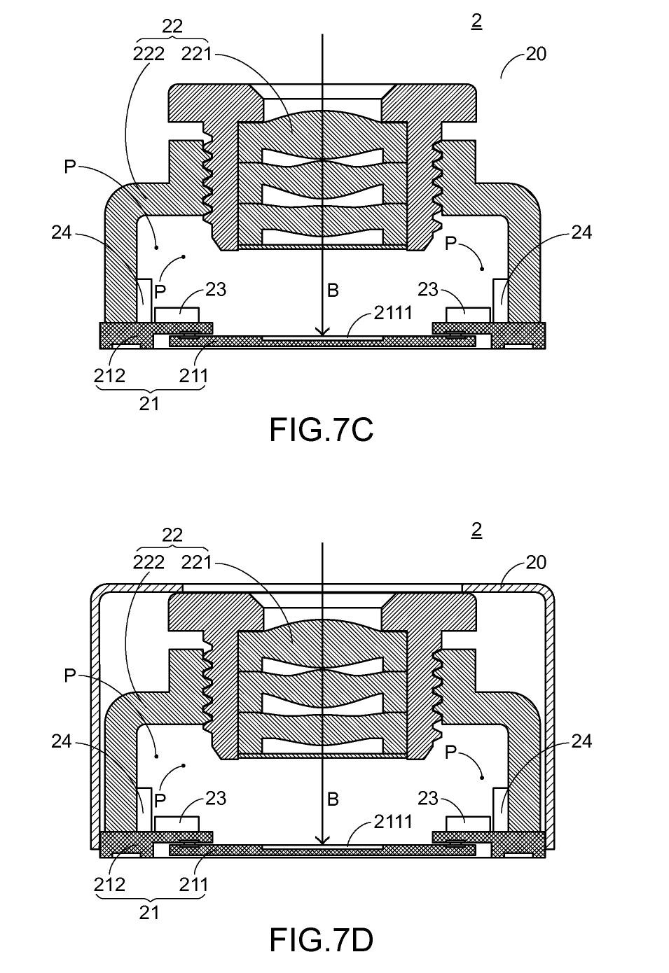

The detailed procedures of the method for cleaning off the particles within the camera module will be illustrated as follows. Please refer to FIGS. 5 and 6. For assembling the camera module 2, plural first gluing elements 23 are firstly attached on external sides of the sensing region 2111 of the sensing chip 21, respectively. Especially, the plural first gluing elements 23 are not disposed on the sensing region 2111. Meanwhile, the step D is performed, and the resulting structure is shown in FIG. 7A. The plural first gluing elements 23 are arranged around the sensing region 2111. After the plural first gluing elements 23 are disposed on the sensing chip 21, the step E is performed. In the step E, plural second gluing elements 24 are sequentially attached on plural inner sidewalls 2221 of the lens carrier 222 (see FIG. 7B).

After the plural second gluing elements 24 are attached on the plural inner sidewalls 2221 of the lens carrier 222, the step F is performed. That is, the lens carrier 222 of the lens module 22 and the circuit board 212 of the sensing chip 21 are combined together. Moreover, the sensing chip 21 is covered by the lens module 221 and the lens carrier 222, and the sensing chip 21 is not exposed outside. Consequently, the lens assembly 221 is disposed over the sensing element 211 and aligned with the sensing element 211. Moreover, the plural first gluing elements 23 and the neighboring second gluing elements 24 are perpendicular to each other. The resulting structure of the combination of the lens carrier 222 and the circuit board 212 is shown in FIG. 7C. After the casing 20 is arranged around the lens carrier 222, the camera module 2 is assembled (see FIG. 7D). Meanwhile, the process of assembling the camera module 2 is completed.

After the camera module 2 is assembled, the step G1 is performed. That is, the camera module 2 is fixed on a vibration generator (not shown). Then, the sub-step G2 is performed. That is, the vibration generator is enabled to drive the camera module 2, so that the camera module 2 is subject to a vibration. In response to the vibration of the camera module 2, the plural particles P within the camera module 2 are moved to the plural first gluing elements 23 at the external sides of the sensing region 2111, or the plural particles P within the camera module 2 are moved to the plural second gluing elements 24 on the plural inner sidewalls 2221 of the lens carrier 222. In this embodiment, the plural first gluing elements 23 and the plural second gluing elements 24 are double-sided tapes. An example of the vibration generator is a centrifuge, an electric field generator or a robotic arm.

In comparison with the camera module 1 of the first embodiment, the camera module 2 of this embodiment is additionally equipped with the plural second gluing elements 24 on the plural inner sidewalls 2221 of the lens carrier 222. Consequently, more particles P can be adsorbed on the plural first gluing elements 23 or the plural second gluing elements 24. The method for cleaning off the particles within the camera module according to this embodiment is distinguished from the method of the first embodiment by the following two items. Firstly, the plural second gluing elements 24 are disposed on the plural inner sidewalls 2221 of the lens carrier 222. Moreover, the vibration generator is used to vibrate the camera module 2. Since the vibration applied to the camera module 2 is enhanced, the possibility of falling down the particles P on the sensing region 2111 is largely reduced.

Moreover, the following two aspects should be specially described. Firstly, in this embodiment, the step D is performed before the step E. Alternatively, in another embodiment, the step E is performed before the step D. Alternatively, in another embodiment, the step D and the step D are simultaneously done. Secondly, the camera module may be modified. It is known that plural first contacts (not shown) are disposed on the sensing element 211 and plural second contacts (not shown) corresponding to the plural first contacts are disposed on the circuit board 212. Moreover, the first contacts are connected with the corresponding second contacts through corresponding gold traces (not shown). Since the plural first contacts are located at a side of the sensing region 2111 and are not disposed on the sensing region 2111, the plural first gluing elements 23 may be disposed on the first contacts and the corresponding gold traces. Since the plural first gluing elements 23 may be disposed on the first contacts and the corresponding gold traces, other components may be the original locations of the plural first gluing elements 23. Consequently, the utilization of the internal space of the camera module 2 is enhanced. Moreover, the efficacy of preventing the particles from falling down to the sensing region is achieved, and the first contacts and the corresponding gold traces are protected by the plural first gluing elements 23.

From the above descriptions, the present invention provides a method for cleaning off particles within a camera module. During the process of assembling the camera module, gluing elements are attached on a sensing element or an inner sidewall of a lens carrier. Consequently, the gluing elements are disposed within the camera module, and the gluing elements are not overlapped with the sensing region of the sensing chip. After the camera module is assembled, a vibrating means is performed to vibrate the camera module. In response to the vibration of the camera module, the particles within the camera module are moved to and adsorbed on the gluing elements. Consequently, the efficacy of preventing the particles from falling down to the sensing region is achieved. In other words, the cleaning method and the camera module of the present invention can largely reduce the possibility of falling down the particles on the sensing region while maintaining the cleanness of the sensing chip.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method for cleaning off particles within a camera module, the method comprising steps of:
(A) attaching a gluing element on a sensing chip of the camera module, wherein the gluing element is located at a side of a sensing region of the sensing chip, and the gluing element is not disposed on the sensing region;
(B) combining the sensing chip and a lens module together as the camera module; and
(C) allowing the camera module to be subject to a vibration, wherein the particles are moved to and adsorbed on the gluing element in response to the vibration of the camera module.

2. The method according to claim 1, wherein before the step (B), the method further comprises a step (D) of attaching an additional gluing element on an inner sidewall of a lens carrier of the lens module.

3. The method according to claim 1, wherein the step (C) comprises sub-steps of:
(C1) fixing the camera module on a vibration generator; and
(C2) enabling the vibration generator to vibrate the camera module.

4. A camera module, comprising:
a sensing chip having a sensing region, wherein the sensing region receives an external light beam and produces an image;
a lens module covering the sensing chip, wherein after the external light beam passes through the lens module, the external light beam strikes the sensing chip; and
a gluing element disposed on the sensing chip and located at a side of the sensing region, wherein when the camera module is subject to a vibration, particles within the camera module are moved to and adsorbed on the gluing element.

5. The camera module according to claim 4, wherein the sensing chip comprises:
a sensing element receiving the external light beam and producing the image, wherein the sensing region is formed on the sensing element; and
a circuit board connected with the sensing element and the lens module, and supporting the sensing element, wherein the gluing element is disposed on the circuit board and located at a side of the sensing element.

6. The camera module according to claim 5, wherein the lens module comprises:
a lens assembly disposed over the sensing element and aligned with the sensing element; and
a lens carrier connected with the circuit board, and supporting the lens assembly.

7. The camera module according to claim 6, further comprising an additional gluing element, wherein the additional gluing element is disposed on an inner sidewall of the lens carrier, wherein when the camera module is subject to the vibration, the particles within the camera module are moved to and adsorbed on the additional gluing element in response to the vibration of the camera module.

8. The camera module according to claim 4, wherein the gluing element is an adhesive or a double-sided tape.

9. The camera module according to claim 4, wherein the camera module is fixed on a vibration generator, wherein when the vibration generator is enabled, the camera module is driven and vibrated by the vibration generator.

10. The camera module according to claim 9, wherein the vibration generator is a centrifuge, an electric field generator or a robotic arm.
